(19) United States
(12) Patent Application Publication
(10) Pub. No.: US 2012/0166397 A1
(43) Pub. Date: Jun. 28, 2012

(54) DEVICE AND METHOD FOR MANAGING ENVIRONMENT OF SYSTEM

(75) Inventors: Jeong-Woo LEE, Daejeon (KR); Oh Cheon KWON, Daejeon (KR); Shin Kyung LEE, Daejeon (KR)

(73) Assignee: ELECTRONICS AND TELECOMMUNICATIONS RESEARCH INSTITUTE, Daejeon (KR)

(21) Appl. No.: 13/332,807

(22) Filed: Dec. 21, 2011

(30) Foreign Application Priority Data
Dec. 23, 2010 (KR) 10-2010-0133658

(51) Int. Cl. G06F 17/30; G06F 7/00

(52) U.S. Cl. 707/687; 707/771; 707/E17.005; 707/E17.014

(57) ABSTRACT

A method in which a system environment management device manages user environment information, the method includes: connecting to a first user terminal; searching for and reading personal information and environment setting information of the first user terminal; analyzing the personal information and environment setting information; determining whether the analyzed personal information and environment setting information is a common element; and storing, if the analyzed personal information and environment setting information is a common element, the analyzed personal information and environment setting information in a common profile storage unit of the system environment management device.

### CROSS-REFERENCE TO RELATED APPLICATION

This application claims priority to and the benefit of Korean Patent Application No. 10-2010-0133658 filed in the Korean Intellectual Property Office on Dec. 23, 2010, the entire contents of which are incorporated herein by reference.

### BACKGROUND OF THE INVENTION

(a) Field of the Invention

The present invention relates to a device and method for managing environment of a system.

(b) Description of the Related Art

A user can use various systems and apparatuses. At this time, the user's information can be applied to environment of a system or can set working environment in which the user prefers. Because the user information that is set in this way is used as different types and specifications in a system and apparatus in which the user uses, whenever the user uses the respective system or apparatus, the user should newly input or set information. Further, even if the user uses a system and apparatus of the same type, when the user uses a system and apparatus in which the user has not used, such a process should be performed.

### SUMMARY OF THE INVENTION

The present invention has been made in an effort to provide a device and method for managing environment of a system having advantages of simply setting working environment in which a user prefers without additional effort or environment setting when the user uses various systems or apparatuses.

An exemplary embodiment of the present invention provides a method in which a system environment management device manages user environment information, the method including: connecting to a first user terminal; searching for and reading personal information and environment setting information of the first user terminal; analyzing the personal information and environment setting information; determining whether the analyzed personal information and environment setting information is a common element; and storing, if the analyzed personal information and environment setting information is a common element, the analyzed personal information and environment setting information in a common profile storage unit of the system environment management device.

The method may further include storing, if the analyzed personal information and environment setting information is not a common element, the analyzed personal information and environment setting information in an individual profile storage unit of the system environment management device.

The method may further include: connecting to a second user terminal; and setting use environment of the second user terminal based on the analyzed personal information and environment setting information.

The setting of use environment of the second user terminal may include searching for and reading individual information and environment setting information of the second user terminal.

The setting of use environment of the second user terminal may further include searching for a necessary profile in the profile storage unit.

The setting of use environment of the second user terminal may further include: collecting, if a necessary profile is stored in the profile storage unit, the necessary profile; and changing use environment of the second user terminal based on the collected profile.

The collecting of the necessary profile may be performed based on the number of use frequency of the user.

The method may further include converting the collected profile to correspond to use environment of the second user terminal.

The setting of use environment of the second user terminal may further include setting, if a necessary profile is not stored in the profile storage unit, the use environment by selection of the second user terminal.

Another embodiment of the present invention provides a method in which a system environment management device manages user environment information, the method including: connecting to a first user terminal; converting a profile that is collected from personal information and environment setting information of a previously stored second user terminal to correspond to use environment of the first user terminal; and setting use environment of the first user terminal based on the converted profile.

The method may further include: separately storing existing individual information and environment setting information of the first user terminal as existing information; storing individual information and environment setting information that is used for the first user terminal after use of the first user terminal is terminated; and restoring the existing information.

Yet another embodiment of the present invention provides a system environment management device that sets use environment of a second user terminal based on a first user terminal, the system environment management device including: an input/output unit that transmits/receives data to and from each of the first user terminal and the second user terminal; a profile data storage unit that receives and stores a profile that is used for the first user terminal through the input/output unit; and an analyzing and processing unit that recognizes a profile in which the second user terminal requests and that sets use environment of the second user terminal based on contents that are stored in the profile data storage unit.

The system environment management device may further include a converter that converts contents that are stored in the profile data storage unit according to a request of the analyzing and processing unit to correspond to the second user terminal.

The profile data storage unit may store a profile that is used for the first user terminal in an extensible markup language (xml) standard form.

The profile data storage unit may include a common profile storage unit that stores a profile in which the first user terminal commonly uses with other user terminals, and an individual profile storage unit that stores a profile that is inherently set to the first user terminal.

The common profile storage unit may store at least one of a static profile, which is information that does not change and a dynamic profile, which is information that changes.

The profile data storage unit may further include an environment configuration information storage unit that stores a profile that sets to correspond to user preference.

The profile data storage unit may further include a use history profile storage unit that stores a profile of a system environment use history of the user.

Yet another embodiment of the present invention provides a system environment management device including: a converter that converts a profile that collects from previously stored individual information and environment setting information of a first user terminal to correspond to use environment of a second user terminal; and an analyzing and processing unit that sets use environment of the second user terminal based on the converted profile.

The system environment management device may further include a use history profile storage unit that stores the set use environment.

### BRIEF DESCRIPTION OF THE DRAWINGS

FIG. 1 is a schematic diagram illustrating operating environment of a system environment management device according to an exemplary embodiment of the present invention.

FIG. 2 is a block diagram of a system environment management device according to an exemplary embodiment of the present invention.

FIG. 3 is a flowchart illustrating a process in which a system environment management device acquires necessary data from a user terminal in a method of managing environment of a system according to an exemplary embodiment of the present invention.

FIG. 4 is a flowchart illustrating a process in which a system environment management device sets system environment of a user terminal in a method of managing environment of a system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising”, will be understood to imply the inclusion of stated elements but not the exclusion of any other elements. In addition, the terms “-er”, “-or” and “module” described in the specification mean units for processing at least one function and operation and can be implemented by hardware components or software components and combinations thereof.

Hereinafter, a device and method for managing environment of a system according to an exemplary embodiment of the present invention will be described in detail with reference to the drawings.

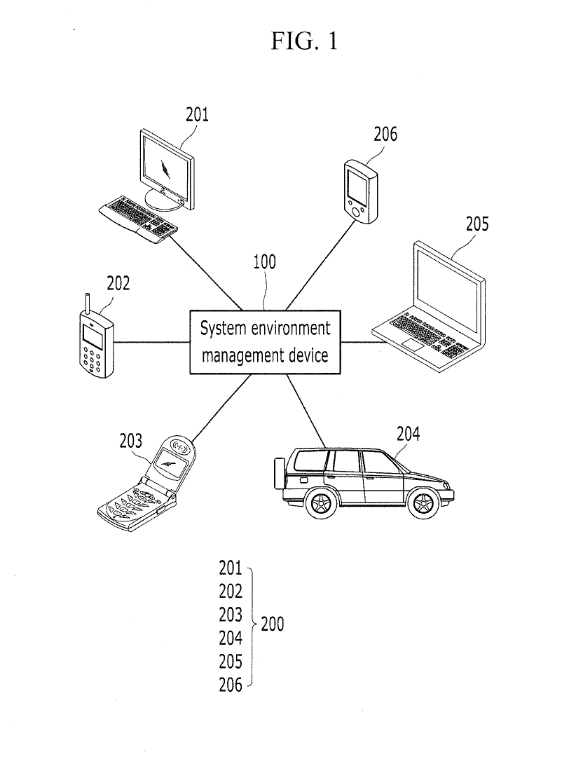

FIG. 1 is a schematic diagram illustrating operating environment of a system environment management device according to an exemplary embodiment of the present invention.

Referring to FIG. 1, a system environment management device 100 is connected to various user terminals 200 to set working environment of the user terminal 200 to correspond to user preference.

The user terminal 200 may be a desktop computer 201, various types of mobile phones 202, 203, and 206, a terminal 204 such as a navigation device that is mounted to a vehicle, and a laptop computer 205.

Different operating systems (OS) or software is applied to the user terminal 200, and because such an OS or software uses a type or a specification corresponding to the user terminal 200, when the user uses another user terminal 200, environment of an OS or software should be set again and constructed. In this case, the system environment management device 100 sets the same environment to the another user terminal 200.

For example, when a user wishes to equally use environment setting such as favorite, Internet environment, and a speaker volume that are used in the user's desk top computer 201 in the smart phone 206, if the user connects each of the desk top computer 201 and the smart phone 206 to the system environment management device 100, working environment that is set to the desk top computer 201 is equally set to the smart phone 206.

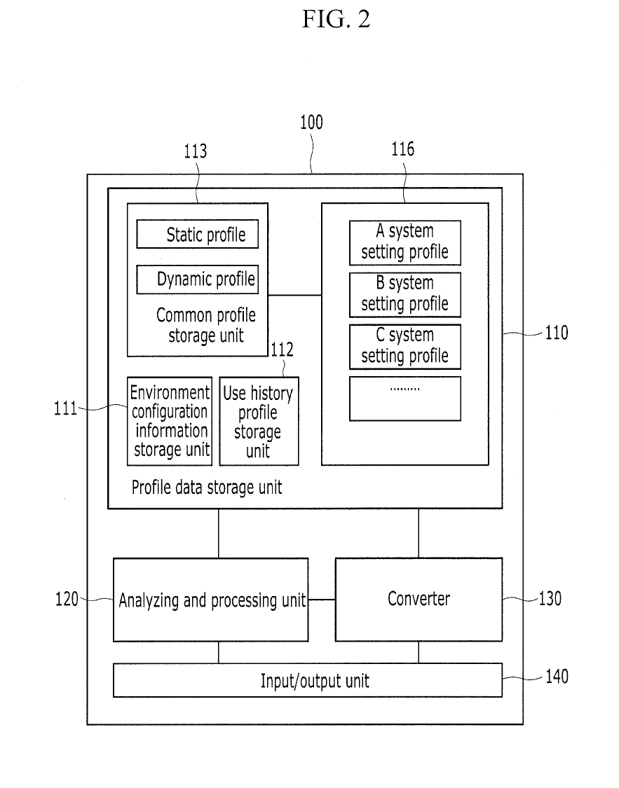

Hereinafter, the system environment management device 100 will be described in detail with reference to FIG. 2.

FIG. 2 is a block diagram of a system environment management device according to an exemplary embodiment of the present invention.

Referring to FIG. 2, the system environment management device 100 includes a profile data storage unit 110, an analyzing and processing unit 120, a converter 130, and an input/output unit 140.

The profile data storage unit 110 stores a profile that is used for the user terminal 200 and stores a profile in an extensible markup language (xml) standard type. The profile data storage unit 110 includes an environment configuration information storage unit 111, a use history profile storage unit 112, a common profile storage unit 113, and an individual profile storage unit 116.

The environment configuration information storage unit 111 stores a profile that is set by a user in various user terminals 200 to allow the user to use to correspond to user preference.

The use history profile storage unit 112 stores a profile of a system environment use history of an individual. The use history profile storage unit 112 stores the number of use of a profile that is used for environment setting and previously provides environment setting in which a user prefers based on the number of use.

The common profile storage unit 113 stores a profile in which the user terminal 200 commonly uses and stores a static profile and a dynamic profile. The static profile is a profile that commonly uses without changing, such as a user's name, social security number, birthdate, vehicle registration number, vehicles identification number (VIN), etc., and the dynamic profile is a profile such as an address, a phone number, Internet setting environment, and favorite that are commonly used but can be changed.

Upon subscribing to a Web portal site and a social network service (SNS), as a user writes and commonly uses an individual profile based on an xml, whenever the user subscribes to another Web portal site and another SNS as a member, such a common profile makes unnecessary for the user to re-input user information.

The individual profile storage unit 116 stores an inherently set profile according to each system.

The analyzing and processing unit 120 recognizes a profile type that is requested by each user terminal 200, searches for a profile that is presently stored in the profile data storage unit 110, finds an appropriate profile, and determines a method of processing the profile. In this case, a method of forming information or environment that is requested for setting environment in various user terminals 200 sets environment of each user terminal 200 with reference to contents that are stored in the environment configuration information storage unit 111.

Further, the analyzing and processing unit 120 analyzes and classifies newly input profile contents and stores the analyzed and classified profile contents in the profile data storage unit 110.

The converter 130 converts a profile type to a profile type that can be applied to the present user terminal 200 according to a request of the analyzing and processing unit 120. Therefore, the converter 130 stores information about an environment setting type or a specification that can be used for various user terminals 200.

The input/output unit 140 processes input/output of profile related data through an input/output interface such as a universal serial bus (USB).

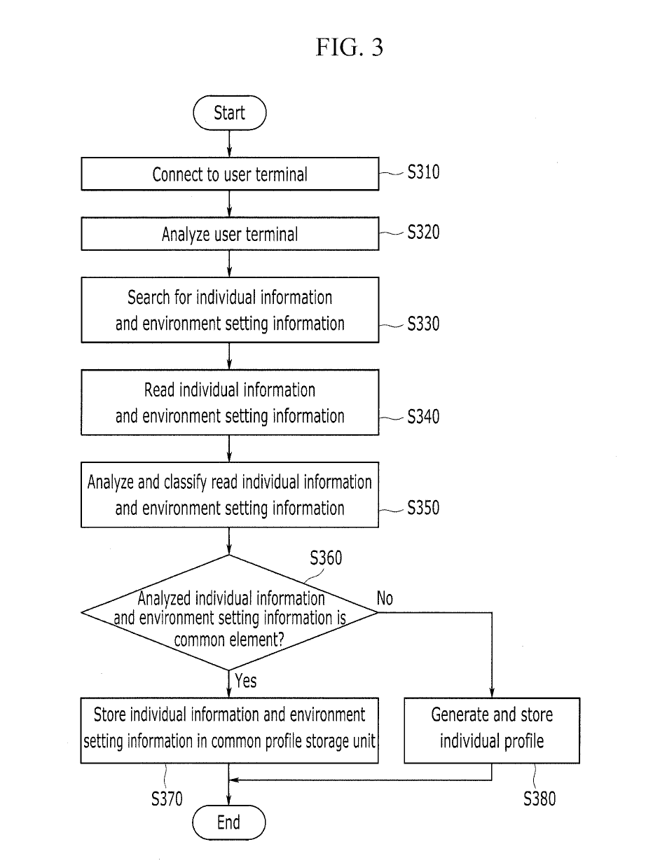

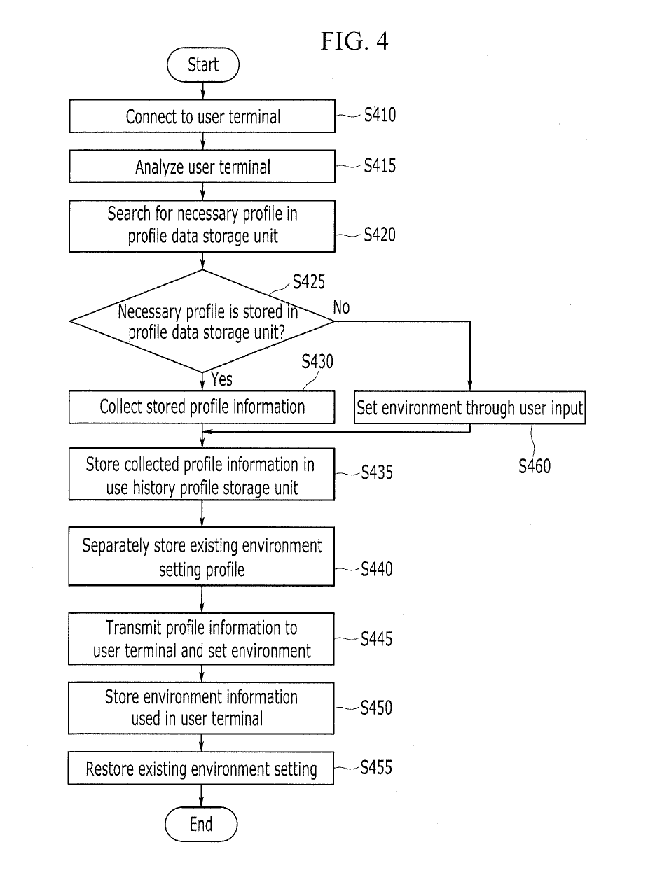

Hereinafter, a method of managing environment of a system according to an exemplary embodiment of the present invention will be described in detail with reference to FIGS. 3 and 4. Here, in the system environment management device 100, a user terminal in which a user originally uses is assumed as a desk top computer 201, and a user terminal in which a user tries to newly set system environment is assumed as the smart phone 206.

FIG. 3 is a flowchart illustrating a process in which a system environment management device acquires necessary data from a user terminal in a method of managing environment of a system according to an exemplary embodiment of the present invention, and FIG. 4 is a flowchart illustrating a process in which a system environment management device sets system environment of a user terminal in a method of managing environment of a system according to an exemplary embodiment of the present invention.

Referring to FIG. 3, the system environment management device 100 is connected to the desk top computer 201 to store environment setting of the user terminal 200 in which a user uses (S310).

Thereafter, the system environment management device 100 analyzes the desk top computer 201 (S320). Thereafter, the system environment management device 100 searches for individual information and environment setting information from the desk top computer 201 (S330) and reads the found individual information and environment setting information (S340).

Thereafter, the system environment management device 100 analyzes and classifies the read individual information and environment setting information (S350).

Thereafter, the system environment management device 100 determines whether the analyzed individual information and environment setting information is a common element (S360). If the analyzed individual information and environment setting information is a common element, the system environment management device 100 stores the individual information and environment setting information in the common profile storage unit 113 (S370). If the analyzed individual information and environment setting information is not a common element, the system environment management device 100 generates an individual profile and stores the individual profile in the individual profile storage unit 116 (S380).

Referring to FIG. 4, the system environment management device 100 is connected to the smart phone 206 for setting system environment (S410). Thereafter, the system environment management device 100 analyzes the smart phone 206 and grasps individual information and environment setting information necessary for environment setting (S415).

Thereafter, the system environment management device 100 searches for a necessary profile in the profile data storage unit 110 based on grasped contents (S420) and determines whether a necessary profile is stored in the profile data storage unit 110 (S425).

If a necessary profile is stored in the profile data storage unit 110, the system environment management device 100 collects the stored profile information (S430). Collection of profile information from the profile data storage unit 110 can be automatically performed based on a user's use frequency. In this case, when it is necessary to convert profile information in the smart phone 206, the profile information can be converted in a necessary type through the converter 130.

Thereafter, the system environment management device 100 stores the collected profile information in the use history profile storage unit 112 (S435). The system environment management device 100 records the number of use of profile information in the use history profile storage unit 112 and can use the number of use when recommending environment setting according to user preference.

Thereafter, the system environment management device 100 separately stores an existing environment setting profile (S440). Thereafter, the system environment management device 100 transmits the collected profile information to the smart phone 206 and sets environment (S445).

When a connection between the system environment management device 100 and the smart phone 206 is released, environment information that is presently set to the smart phone 206 is stored again in the system environment management device 100 (S450), existing environment setting of the smart phone 206 is restored based on a profile that has been stored at a separate storage location immediately before release (S455).

If a necessary profile is not stored in the profile data storage unit 110 at step S425, environment is set through user input (S460).

According to the present invention, when a user uses various systems or apparatuses, working environment in which the user prefers can be simply set without additional effort or environment setting.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a system environment management device manages user environment information, the method comprising:
connecting to a first user terminal;
searching for and reading personal information and environment setting information of the first user terminal;
analyzing the personal information and environment setting information;
determining whether the analyzed personal information and environment setting information is a common element; and
storing, if the analyzed personal information and environment setting information is the common element, the analyzed personal information and environment setting information in a common profile storage unit of the system environment management device.

2. The method of claim 1, further comprising storing, if the analyzed personal information and environment setting information is not the common element, the analyzed personal information and environment setting information in an individual profile storage unit of the system environment management device.

3. The method of claim 2, further comprising:
connecting to a second user terminal; and
setting use environment of the second user terminal based on the analyzed personal information and environment setting information.

4. The method of claim 3, wherein the setting of use environment of the second user terminal comprises searching for and reading individual information and environment setting information of the second user terminal.

5. The method of claim 4, wherein the setting of use environment of the second user terminal further comprises searching for a necessary profile in the profile storage unit.

6. The method of claim 5, wherein the setting of use environment of the second user terminal further comprises:
collecting, if a necessary profile is stored in the profile storage unit, the necessary profile; and
changing use environment of the second user terminal based on the collected profile.

7. The method of claim 6, wherein the collecting of the necessary profile is performed based on the number of use frequency of the user.

8. The method of claim 7, further comprising converting the collected profile to correspond to use environment of the second user terminal.

9. The method of claim 5, wherein the setting of use environment of the second user terminal further comprises setting, if a necessary profile is not stored in the profile storage unit, the use environment by selection of the second user terminal.

10. A method in which a system environment management device manages user environment information, the method comprising:
connecting to a first user terminal;
converting a profile that is collected from personal information and environment setting information of a previously stored second user terminal to correspond to use environment of the first user terminal; and
setting use environment of the first user terminal based on the converted profile.

11. The method of claim 10, further comprising:
separately storing existing individual information and environment setting information of the first user terminal as existing information;
storing individual information and environment setting information that is used for the first user terminal after use of the first user terminal is terminated; and
restoring the existing information.

12. A system environment management device that sets use environment of a second user terminal based on a first user terminal, the system environment management device comprising:
an input/output unit that transmits/receives data to and from each of the first user terminal and the second user terminal;
a profile data storage unit that receives and stores a profile that is used for the first user terminal through the input/output unit; and
an analyzing and processing unit that recognizes a profile in which the second user terminal requests and that sets use environment of the second user terminal based on contents that are stored in the profile data storage unit.

13. The system environment management device of claim 12, further comprising a converter that converts contents that are stored in the profile data storage unit according to a request of the analyzing and processing unit to correspond to the second user terminal.

14. The system environment management device of claim 12, wherein the profile data storage unit stores a profile that is used for the first user terminal in an extensible markup language (xml) standard form.

15. The system environment management device of claim 12, wherein the profile data storage unit comprises a common profile storage unit that stores a profile in which the first user terminal commonly uses with other user terminals, and an individual profile storage unit that stores a profile that is inherently set to the first user terminal.

16. The system environment management device of claim 15, wherein the common profile storage unit stores at least one of a static profile, which is information that does not change and a dynamic profile, which is information that changes.

17. The system environment management device of claim 15, wherein the profile data storage unit further comprises an environment configuration information storage unit that stores a profile that sets to correspond to user preference.

18. The system environment management device of claim 17, wherein the profile data storage unit further comprises a use history profile storage unit that stores a profile of a system environment use history of the user.

19. A system environment management device comprising:
a converter that converts a profile that collects from previously stored individual information and environment setting information of a first user terminal to correspond to use environment of a second user terminal; and
an analyzing and processing unit that sets use environment of the second user terminal based on the converted profile.

20. The system environment management device of claim 19, further comprising a use history profile storage unit that stores the set use environment.
